(19) United States
(12) Patent Application Publication
(10) Pub. No.: US 2016/0195565 A1
(43) Pub. Date: Jul. 7, 2016

(54) METHOD AND DEVICE FOR WASHING A PIPETTING-DISPENSING DEVICE

(71) Applicant: NOVACYT, Velizy Villacoublay (FR)

(72) Inventor: Eric PELTIER, Clamart (FR)

(21) Appl. No.: 14/911,226

(22) PCT Filed: Aug. 8, 2014
(86) PCT No.: PCT/EP2014/067122

§ 371 Date: Feb. 9, 2016

(30) Foreign Application Priority Data
Aug. 9, 2013 (FR) 1357925

(51) Int. Cl. G01N 35/10; B08B 9/023; B08B 9/032; B08B 3/08

(52) U.S. Cl. CPC G01N 35/1004; B08B 3/08; B08B 9/023; B08B 9/0321

(57) ABSTRACT

The pipetting-dispensing device (12) comprises at least one tubular pipetting-dispensing needle (14). The method comprises at least one step for rinsing the pipetting-dispensing device (12) using a detergent product, said product being injected into an upstream end (18) of the needle (14) and dispensed from said needle (14) by a downstream end (20).

The method further comprises the following steps:
pipetting a mucolytic product through the downstream end (20) of the needle (14)
dispensing said mucolytic product through said downstream end (20),
pipetting a disinfectant product through the downstream end (20) of the needle (14), and
dispensing said disinfectant product through said downstream end (20).

### FIELD OF THE INVENTION

The present invention relates to a method for washing a pipetting-dispensing device, of the type comprising at least one step for rinsing the pipetting-dispensing device using a detergent product, said product being injected into an upstream end of the needle and dispensed from said needle by a downstream end.

The invention also relates to a washing device able to implement such a method.

### BACKGROUND OF THE INVENTION

The washing method and device according to the invention are for example designed to allow the washing of the pipetting-dispensing device provided in an automated device for preparing analysis slides from cytological samples, such as uterine or other smears. Such an automated device is for example described in document WO-2011/117523. This automated device comprises a plurality of needles arranged to perform a plurality of operations, such as placing a smear in suspension, recovering samples from the cell suspension, depositing the samples in analysis containers, optionally with intermediate steps for mixing samples in the needles, replacing the samples in suspension and/or remixing samples with a marker or other product, as described in document WO-2011/117523. These operations are performed at a fast pace from a multitude of smears in order to prepare analysis slides or other analysis containers ready for subsequent analysis by a practitioner.

It will be understood that in such an automated device, it is crucial to avoid any contamination of smears and samples, whether external contamination or contamination of the samples by one another. Indeed, such a contamination would make the produced analysis containers completely unusable or could lead to erroneous diagnostics.

To do this, it has been proposed to replace the needles between the treatment of successive smears such that each needle is used only once and only performs operations relative to a single smear, which makes it possible to avoid any risk of contamination of the smears by one another. The needles are then made in the form of consumable products disposable after one use. Such consumables considerably increase the operating costs of an automated device and create waste management problems, in particular contaminated and potentially environmentally hazardous waste. Furthermore, it is necessary to provide means for replacing needles between each smear treatment cycle, which makes the automated device more complex and reduces the treatment speeds. Furthermore, such systems can generate the aerosolization of microparticles, since they use mixing means using air.

According to another solution, it is provided to clean the needles between the treatment of successive samples using a detergent product. The automated device then comprises a rinsing device making it possible to inject a detergent product in each needle between each treatment cycle. This injection is done from the upstream end of the needle, i.e., from the end of the needle opposite the end by which the various smears are done, using a pump connected to a detergent product reservoir. The pump suctions the detergent product from the reservoir and injects it through the upstream end of the needle, which dispenses the product through its downstream end. The product may optionally be dispensed in a rinsing chamber, in which the needle is positioned. Thus, the dispensed product fills the chamber and cleans the outer surface of the needle.

Such a known washing device makes it possible to clean the needles superficially, but is not sufficient over the long term. Indeed, over the course of the use of the automated device, mucus or other similar substances from cell smears become deposited on the needles, while the detergent product is not able to dispense this mucus or these substances. Thus, the mucus can cause closing off of the needles or pollution of the rest of the automated device. Furthermore, the mucus increases cell adhesion on the needles, which reduces the effectiveness of the detergent product and over time can lead to cross-contamination between the smears. Lastly, the detergent product is not able to destroy any viruses that may be pipetted by the pipetting-dispensing device, which increases the risks of contamination of the samples, in particular in performing molecular biology techniques (for example, HPV reflex testing).

### SUMMARY OF THE INVENTION

One of the aims of the invention is to offset these drawbacks by proposing a method for washing a pipetting-dispensing device that is more effective and guarantees the elimination or dispense of the pollutants or contaminants of the pipetting-dispensing device.

To that end, the invention relates to a method of the aforementioned type, in which said method further comprises the following steps:
pipetting a mucolytic product through the downstream end of the needle,
dispensing said mucolytic product through said downstream end,
pipetting a disinfectant product through the downstream end of the needle, and
dispensing said disinfectant product through said downstream end.

Pipetting a mucolytic product during a cleaning cycle makes it possible to dispense the mucus deposited on the needles and thus eliminates the closing off or cell adhesion risks. Pipetting a disinfectant product avoids creating a biofilm and makes it possible to destroy the microorganisms, such as viruses, bacteria or fungi, potentially pipetted during the treatment of the cell smears. Performing pipetting steps through the downstream end of the needles, by suction whereas traditional washing is done by dispensing, further makes it possible to create turbulence in the pipetting-dispensing device and thus improves the circulation of the washing products. Furthermore, this prevents the mucolytic product and the detergent product from passing through the suction and dispensing device positioned upstream from the needle, and thus from damaging this device, which is generally formed by a volume displacement pump or peristaltic pump. Furthermore, some steps may be carried out without the needle leaving the vial containing a cell suspension, which makes it possible to protect against risks of cross-contamination between the different cell suspensions to be analyzed.

According to other features of the method according to the invention:
the rinsing step using a detergent comprises a step for dispensing the detergent in a washing chamber, the needle being submerged in the detergent dispensed into said washing chamber;
the step for pipetting a mucolytic product is followed by a step for pipetting a volume of cell suspension, such that the mucolytic product penetrates the needle before the cell suspension and leaves the needle after the cell suspension;
at least part of the pipetted volume of mucolytic product is mixed with the volume of pipetted cell suspension, the dispensing of said part of the mucolytic product volume being done simultaneously with the dispensing of the cell suspension volume;
the step for dispensing the cell suspension volume and the mucolytic product is done against the wall of a vial containing the cell suspension so as to break the mucus and cell clusters present in the cell suspension volume;
the injection, dispensing and pipetting of product in the needle are done by a suction and dispensing device in fluid communication with the upstream end of the needle by means of a tube;
the pipetting steps are arranged so that the pipetted product passes through the needle from the downstream end to the upstream end and penetrates the tube connecting the upstream end of the needle to the suction and dispensing device, the dispense steps being carried out before the pipetted product reaches said suction and dispensing device;
the washing method comprises a step for determining the presence and quantity of liquid in the tube carried out using a level sensor provided at the tube; and
the mucolytic product is a dithiothreitol-based solution and the disinfectant product is a bleach-based solution.

The invention also relates to a device for washing a pipetting-dispensing device designed to implement a washing method as described above, said device comprising at least one tubular pipetting-dispensing needle, designed to implement a washing method as defined above, said device comprising a suction and dispensing device provided upstream of the needle and in fluid communication with an upstream end of the needle, a source of detergent product upstream of the suction and dispensing device and in fluid communication with said device such that said device is able to aspirate the detergent product and inject it in the needle by its upstream end, and said device further comprises at least one mucolytic product source and at least one disinfectant product source, the suction and dispensing device being able to aspirate the mucolytic product and the disinfectant product via the downstream end of the needle.

### BRIEF DESCRIPTION OF THE DRAWINGS

Other aspects and advantages of the invention will appear upon reading the following description, provided as an example, and done in reference to the appended drawings, in which:

FIG. 1 is a diagrammatic sectional illustration of a pipetting and analysis automated device, the pipetting-dispensing device of which can be washed using the method according to the invention,

FIG. 2 is a sectional diagrammatic illustration of a washing device according to the invention,

FIG. 3 is a diagram showing the different steps of the washing method according to the invention, and

FIG. 4 is a diagrammatic illustration of a vial during a mixing step of the washing method according to the invention.

### DETAILED DESCRIPTION OF CERTAIN EMBODIMENTS OF THE INVENTION

In the description, the terms “upstream” and “downstream” are defined relative to the flow direction of a detergent liquid in the needle, the liquid being dispensed in the needle by a dispensing device positioned upstream of the needle. Consequently, the dispensing from the needle is done in an upstream-downstream direction, while the suction, or aspiration, is done in a downstream-upstream direction.

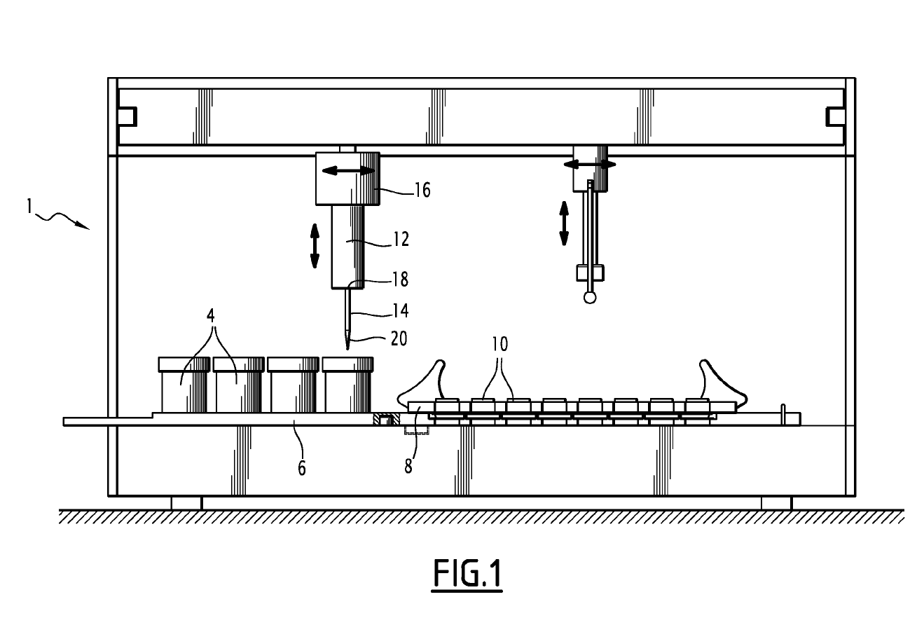

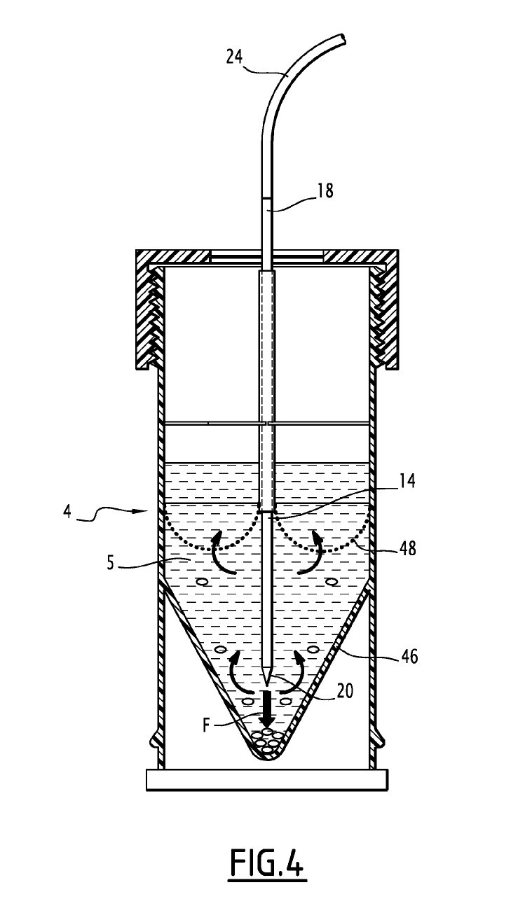

FIG. 1 shows an automated device 1 for preparing and analyzing at least one vial 4 containing a cell suspension 5 to be analyzed (FIG. 4), for example a fixed cytological suspension. The cell suspensions 5 are obtained by suspending cell samples for example obtained during a cervical smear test procedure or by other types of sample-taking. The manner in which the sample that has been taken is placed in suspension and in which the cells are preserved is known and will not be described in detail here.

The automated device 1 essentially comprises a receiving plate 6 for the vials 4 and decanting chambers 10 arranged above analysis slides on which two-dimensional cell samples must be obtained from cell suspensions 5, using a pipetting-dispensing device 12 able to take samples of the cell suspensions 5 and deposit the samples in the decanting chambers 10, optionally going through intermediate treatment steps.

Because the automated device 1 and its operation have been described in document WO-2011/117523, the automated device will not be described here in more detail. One skilled in the art can refer to this document to see all of the other features, details and alternative embodiments. It is understood that the automated device can be suitable for producing types of analysis containers other than analysis slides. For example, the analysis containers 22 of this preparation and analysis system 20 can include, depending on the analysis of chosen by the practitioner, smear slides, sample or aliquoting tubes, and analysis or decanting wells.

The pipetting-dispensing device 12, or pipetting device, extends above the receiving plate 6 and is able to pipet or aspirate, move and pour or dispense various liquid products, in particular samples of cell suspensions 5. To that end, the pipetting-dispensing device 12 comprises a plurality of tubular and hollow needles 14, or pipettes, movable between the different stations of the automated device 1 by an arm 16 and movable vertically to make it possible to lower and raise the needles 14.

Each needle 14 extends between an upstream end 18 and a downstream end 20 in fluid communication with one another.

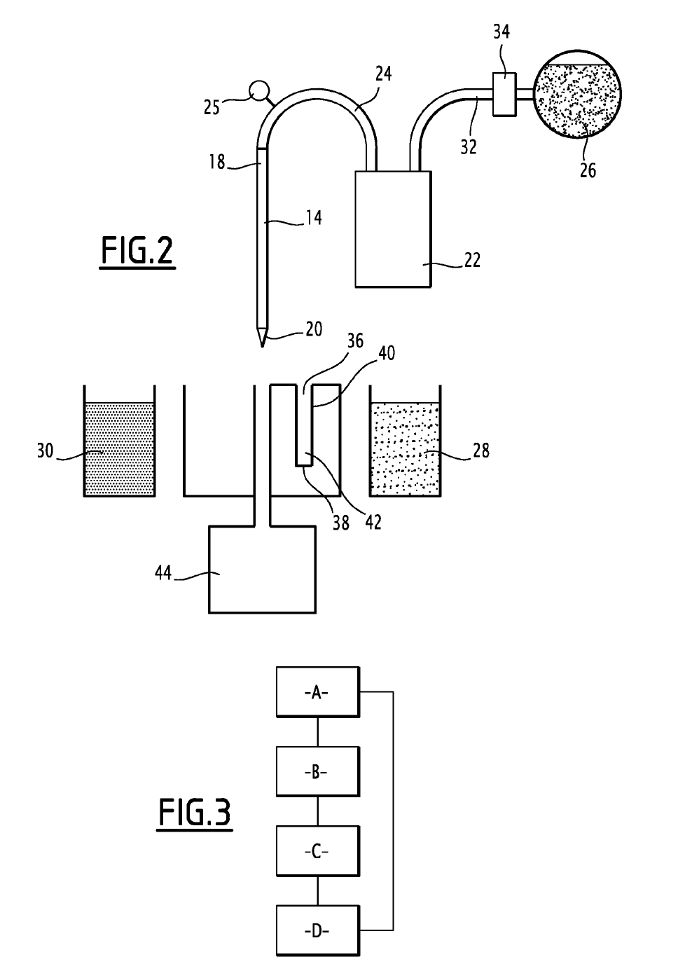

The operations for taking samples of a cell suspension 5 are done by suction, or aspiration, through the downstream end 20 of the needle 14, and the pouring or evacuation operations are done by dispensing through that downstream end 20. To that end, the upstream end 18 of the needle is in fluid communication with a suction and dispensing device 22 positioned upstream of the needle 14 and arranged to allow suctioning of products and dispensing of those products through the downstream end 20 of the needle. To that end, the suction and dispensing device 22 is connected to the upstream end 18 of the needle 14 by a pipe 24, or tube, for example a flexible pipe allowing the movement of the needle 14 relative to the suction and dispensing device 22, as shown in FIG. 2.

The suction and dispensing device 22 is for example formed by a traditional dispensing pump for this type of application, such as a peristaltic pump. Alternatively, the suction and dispensing device 22 could be formed by a piston and/or valve system, or other system. The suction and dispensing device 22 makes it possible to carry out steps involving the pipetting-dispensing device 12 in the operation of the automated device 1. A level sensor 25 is provided at the pipe 24 between the upstream end 18 of the needle 14 and the suction and dispensing device 22 in order to ensure that there is enough cleaning product for complete performance of the washing method.

The suction and dispensing device 22 and the tube 24 and level sensor 25 are also part of a washing device, shown in FIG. 2, making it possible to carry out a method for washing each needle 14, as will now be described.

The method uses at least three cleaning products and the washing device consequently comprises a source for each of these products, i.e., a detergent product source 26, a mucolytic product source 28 and a disinfectant product source 30.

The detergent product is for example Decon©. The detergent product source 26 is positioned upstream of the suction and dispensing device 22 and is in communication with this device, for example via a flexible tube 32, or pipe. A filter 34 is provided between the detergent product source 26 and the suction and dispensing device 22 in order to filter the cleaning product before injecting it into the rest of the washing device. Thus, the suction and dispensing device 22 is able to suction the detergent product through the flexible tube 32 and inject it into the needle 14 through the flexible pipe 24 and through the upstream end 18 of the needle 14. Under the action of the suction and dispensing device 22, the detergent product can next pass through the needle 14 from its upstream end 18 to its downstream end 20 and the product can be dispensed through its downstream end 20 so as to ensure complete cleaning of the inside of the needle 14.

The mucolytic product is for example formed by a dithiothreitol (DTT) or N-acetylcystein solution. The mucolytic product source 28 is positioned downstream of the needle 14 and is not in permanent fluid communication with the needle 14 or with the suction and dispensing device 22. The pipetting-dispensing device 12 is able to bring the needle 14 toward the mucolytic product source 28 and to place the downstream end 20 of the needle 14 in fluid communication with the source 28 by submerging the needle 14 in the source so as to allow suctioning of the mucolytic product through the downstream end 20 of the needle 14 owing to the suction and dispensing device 22. Under the action of the suction and dispensing device 22, the mucolytic product can next pass through the needle 14 from its downstream end 20 to its upstream end 18 and enter the pipe 24 downstream of the suction and dispensing device 22. The level sensor 25 makes it possible to ensure that a sufficient quantity of mucolytic product is pipetted owing to the suction and dispensing device 22. In order to prevent the mucolytic product from penetrating the suction and dispensing device 22, the mucolytic product source is positioned downstream of the needle 14 and not upstream of the suction and dispensing device 22, as is provided for the detergent product.

The disinfectant product is for example formed by a bleach-based solution, for example diluted bleach, for example at 2%, or a solution containing bleach and/or other disinfectant agents. The disinfectant product source 30 is positioned downstream of the needle 14 and is not in permanent fluid communication with the needle 14 or with the suction and dispensing device 22. The pipetting-dispensing device 12 is able to bring the needle 14 toward the disinfectant product source 30 and to place the downstream end 20 of the needle 14 in fluid communication with this source 30 by submerging the needle 14 in the source so as to allow suctioning of the disinfectant product through the downstream end 20 of the needle 14 owing to the suction and dispensing device 22. Under the action of the suction and dispensing device 22, the disinfectant product can next pass through the needle 14 from its downstream end 20 to its upstream end 18 and pass in the pipe 24 downstream of the suction and dispensing device 22. The level sensor 25 makes it possible to ensure that a sufficient quantity of disinfectant product is pipetted owing to the suction and dispensing device 22. The volume of disinfectant product is calculated so as to prevent the product from penetrating the suction and dispensing device 22 and damaging it. It is also in order to prevent the disinfectant product from penetrating the suction and dispensing device 22 that the disinfectant product source is positioned downstream of the needle 14 and not upstream of the suction and dispensing device 22, as is provided for the detergent product. Indeed, the disinfectant product can damage or scratch the suction and dispensing device 22.

The washing device further comprises a cleaning chamber 36 comprising a bottom 38 and a side wall 40 defining an inner volume 42 between them, closed by the bottom 38 on the one hand and open at the end of the side wall 40 opposite the bottom 38 on the other hand. The pipetting-dispensing device 12 is able to place the needle 14 in the inner volume 42. The cleaning product present in the needle 14 can then be dispensed through its downstream end 20 into the cleaning chamber 36 such that it fills the inner volume and coats the outer surface of the needle 14 in the inner volume 42. Thus, the cleaning chamber 36 allows cleaning of the outer surface of the needle 14 with the cleaning product present on the needle.

The washing device further comprises a dispense chamber 44 in which the cleaning products present in the needle 14 can be dispensed by passing through the downstream end 20 of the needle 14.

In reference to FIGS. 2 to 4, we will now describe the operation of the washing device. Several washing modes can be provided, each of the modes involving more or fewer of the washing cycles described below depending on whether the washing is done with the automated device “empty”, i.e., without samples to be treated, or during operation of the automated device between the treatment steps of the samples and depending on whether the washing must be more or less thorough.

After the treatment of a sample of a cell suspension 5 taken through the downstream end 20 of the needle 14, i.e., after the needle 14 has deposited the sample in a decanting chamber 10 to produce an analysis slide, the needle 14 must be cleaned. Steps for cleaning the needle 14 can also take place during the pipetting and dispensing of the sample in the decanting cone of the vial order to avoid the presence of cells and mucus in the needle 14.

During a first washing step A (FIG. 3), the suction and dispensing device 22 is actuated so as to aspirate the detergent product from the detergent source 26 and inject this product into the needle 14 through the upstream end 18 of this needle 14. This step is done while the needle 14 is in the washing chamber 36 or while the needle is in the process of being moved toward this washing chamber 36. When the needle 14 is placed in the washing chamber 36, the detergent product is dispensed from the needle 14 by its downstream end 20 and cleans the outside of the needle 14 as previously described. During this washing step, the detergent product is passed through the filter 34 by which it was filtered, then the flexible tube 32, the suction and dispensing device 22, then through the flexible pipe 24 and the inside of the needle 14, which it has cleaned before cleaning the outside of the needle 14 owing to the washing chamber 36. Thus, a complete cleaning of the pipetting-dispensing device has been done by the detergent product, which can next be dispensed through the dispense chamber 44.

During a second washing step B, the needle 14 is moved in the mucolytic product source 28 and a volume of mucolytic product is pipetted by the downstream end 20 of the needle 14 owing to the suction and dispensing device 22. During this step, the mucolytic product can be suctioned until it reaches a predefined level in the flexible pipe 24 upstream from the needle 14 in order to perform complete cleaning of the inside of the needle 14 and part of the pipe 24 with the mucolytic product without the latter reaching the suction and dispensing means 22. The mucolytic product can next be dispensed through the downstream end 20 of the needle 14, for example in the dispense chamber 44. It should be noted that during this cleaning step, successive suction and dispensing operations can be provided to ensure good circulation of the product and good sweeping of the inner walls of the needle 14 and the flexible pipe 24 by the product, for example by creating turbulence inside the needle 14 and/or the pipe 24. This step makes it possible to dispense the mucus that may accumulate on the needle 14 and close it off or favor cell adhesion on the needle.

It will also be noted that a volume of mucolytic product can be pipetted in the needle 14 before each pipetting of a sample in order to be used for the treatment of a sample pipetted from a cell suspension 5, during a step C. Indeed, the mucolytic product can advantageously be used to break the cell clusters in the cell suspension 5 by destroying the mucus that binds the cells to one another. To that end, the mucolytic product can be mixed with the pipetted sample of the cell suspension 5 and reinjected into the vial 4 with the sample against a wall of the vial 4 in order to break the cell clusters, as shown by arrow F in FIG. 4 and as described in document WO-2011/117523. More particularly, the sample and the mucolytic product can be ejected from the needle 14 against the wall of a decanting cone 46 extending at the bottom of the vial 14. Such a step makes it possible to break the cell clusters of the sample to be analyzed. Such a step is carried out while the needle 14 is in the vial 4 and does not leave it during this step, which avoids any risk of cross-contamination between the contents of the different vials 4.

Furthermore, pipetting mucolytic product before each pipetting of the sample makes it possible to perform an initial cleaning of the needle 14 from downstream to upstream before the sample penetrates the needle 14. During the deposit of the sample in the decanting cone of the vial, a second cleaning of the needle 14 is done from upstream to downstream when the mucolytic product is dispensed from the needle 14. Since the mucolytic enters the needle 14 first and is dispensed therefrom last, it will be ensured that the needle 14 does not retain cells or mucus before and after each pipetting, which limits the risk of cross-contamination between the samples. This step can be combined with the step for mixing with the sample previously described, for example by pipetting a first volume of mucolytic product, responsible for ensuring cleaning before and after the pipetting, and by pipetting a second volume of mucolytic product that penetrates the needle 14 after the first volume and is responsible for mixing with the pipetted sample.

During a step D, taking place between the treatment cycles of the samples by the pipetting-dispensing device, the needle 14 is moved in the disinfectant product source 30 and a volume of disinfectant product is pipetted through the downstream end 20 of the needle 14 owing to the suction and dispensing device 22. During this step, the disinfectant product can be suctioned until it reaches a predefined level in the flexible pipe 24 upstream from the needle 14 in order to perform complete cleaning of the inside of the needle 14 and part of the pipe 24 with the disinfectant product without the latter reaching the suction and dispensing device 22. The disinfectant product can next be dispensed through the downstream end 20 of the needle 14, for example in the dispense chamber 44. It should be noted that during this cleaning step, successive suction and dispensing operations can be provided to ensure good circulation of the product and good sweeping of the inner walls of the needle 14 and the flexible pipe 24 by the product, for example by creating turbulence inside the needle 14 and/or the pipe 24.

The steps for dispensing mucolytic and disinfectant products can also take place in the washing chamber 36 in order to apply this product on the outer surface of the needle 14.

The washing method and device described above make it possible to obtain complete and effective washing of the pipetting-dispensing device 12 while avoiding the use of consumables that are disposable after a single use. The arrangement of the washing device makes it possible to clean the pipetting-dispensing device with several cleaning products without risking damaging the suction and dispensing device 22. It is of course possible to adapt the washing device to clean several needles 14 at the same time, although washing of a single needle has been described above.

Furthermore, when the method involves adding a mucolytic product in the cell suspension, the cell preservation liquid, or fixer, may be more easily adapted to the needs of cytology or molecular biology due to the production of a new cell suspension from the initial cell suspension, the new suspension including the initial cell suspension and the mucolytic product added during the method. Thus, the initial cell suspension, or primary cell suspension, allows good morphological preservation of the cells, since its preservative liquid is adapted to this purpose by containing little or no mucolytic product, while the new cell suspension, or secondary suspension, makes it possible to break up the clusters. Thus, the mucolytic product is added after complete fixing of the cells in the primary suspension, which makes it possible to preserve the cells despite the subsequent addition of the mucolytic product.

1. A method for washing a pipetting-dispensing device, comprising at least one tubular pipetting-dispensing needle, said method comprising:
rinsing the pipetting-dispensing device using a detergent product, said product being injected into an upstream end of the needle and dispensed from said needle by a downstream end,
pipetting a mucolytic product through the downstream end of the needle,
dispensing said mucolytic product through said downstream end,
pipetting a disinfectant product through the downstream end of the needle, and
dispensing said disinfectant product through said downstream end.

2. The washing method according to claim 1, wherein the rinsing using a detergent comprises dispensing the detergent in a washing chamber, the needle being submerged in the detergent dispensed into said washing chamber.

3. The washing method according to claim 1, wherein pipetting the mucolytic product is followed by pipetting a volume of cell suspension, such that the mucolytic product penetrates the needle before the cell suspension and leaves the needle after the cell suspension.

4. The washing method according to claim 3, wherein at least part of the pipetted volume of mucolytic product is mixed with the volume of pipetted cell suspension, the dispensing of said part of the mucolytic product volume being done simultaneously with the dispensing of the cell suspension volume.

5. The washing method according to claim 4, wherein dispensing the cell suspension volume and the mucolytic product is done against a wall of a vial containing the cell suspension so as to break the mucus and cell clusters present in the cell suspension volume.

6. The washing method according to claim 1, wherein the injection, dispensing and pipetting of product in the needle are done by a suction and dispensing device in fluid communication with the upstream end of the needle by a pipe.

7. The washing method according to claim 6, wherein the pipetting steps are arranged so that the pipetted product passes through the needle from the downstream end to the upstream end and penetrates the pipe connecting the upstream end of the needle to the suction and dispensing device, the dispensing steps being carried out before the pipetted product reaches said suction and dispensing device.

8. The washing method according to claim 1, wherein the washing method comprises determining the presence and quantity of liquid in the pipe carried out using a level sensor provided at the pipe.

9. The washing method according to claim 1, wherein the mucolytic product is a dithiothreitol-based solution and wherein the disinfectant product is a bleach-based solution.

10. A device for washing a pipetting-dispensing device, comprising at least one tubular pipetting-dispensing needle, designed to implement a washing method according to claim 1, said device comprising a suction and dispensing device provided upstream from the needle and in fluid communication with an upstream end of the needle, a source of detergent product upstream from the suction and dispensing device and in fluid communication with said suction and dispensing device such that said suction and dispensing device is able to suction the detergent product and inject it in the needle by its upstream end, and wherein the device further comprises at least one mucolytic product source and at least one disinfectant product source, the suction and dispensing device being able to aspirate the mucolytic product and the disinfectant product via the downstream end of the needle.
